(19) United States
(12) Patent Application Publication
(10) Pub. No.: US 2020/0074838 A1
(43) Pub. Date: Mar. 5, 2020

(54) WEARABLE MULTI-FUNCTIONAL PERSONAL SECURITY DEVICE

(71) Applicant: HOLOR, LLC, St. Augusta, MN (US)

(72) Inventor: Kanthi Yalamachili, St. Augusta, MN (US)

(73) Assignee: HOLOR, LLC, St. Augusta, MN (US)

(21) Appl. No.: 16/466,157

(22) PCT Filed: Dec. 5, 2017
(86) PCT No.: PCT/US17/64638

§ 371 Date: Jun. 3, 2019

Related U.S. Application Data
(60) Provisional application No. 62/434,699, filed on Dec. 15, 2016.

(51) Int. Cl. G08B 25/01; G08B 21/02; G08B 25/00

(52) U.S. Cl. CPC G08B 25/016; G08B 21/0269; G08B 25/001; G08B 25/005; G08B 21/0294

(57) ABSTRACT

A multi-functional personal security device includes a housing for wear by a user. The housing contains a position module, a communications module, a smart switch, and first, second, and third security modules. The position module determines a geo-position of the housing. The communications module detects a cellular device. The security modules individually respond to activation of the smart switch to provide respective security functions. Switch activation occurs in response to a pressing sequence of a button and/or voice commands, which may activate the first security function only when the cellular device is present. Activation of the smart switch in response to a second input sequence activates the second and third security functions, e.g., a strobe and audible alarm. Panic, Silent Panic, Countdown, and Tracking Modes may be selectively enabled.

### CROSS-REFERENCE TO RELATED APPLICATIONS

This application is a United States National Stage application of, and therefore claims the benefit of, International Application No. PCT/US2017/064638 filed Dec. 5, 2017, which claims the benefit of U.S. Provisional Application No. 62/434,699, filed Dec. 15, 2016, both of which are hereby incorporated by reference in their respective entireties.

### TECHNICAL FIELD

The present disclosure pertains to a wearable personal security device providing multiple different security functions.

### BACKGROUND

Personal security and safety are prevailing concerns in modern society. An awareness of the myriad of potential threats to person or property may cause people to change their behavior, such as by choosing not to frequent high-risk or isolated locations or by avoiding participation in potentially dangerous activities. Unfortunately, merely being aware of such potential threats is not always sufficient. According to the Criminal Justice Information Services Division of the United States Federal Bureau of Investigation, an estimated 1.2 million violent crimes were committed around the United States in 2015 alone. As a result, some individuals will become victims of crime in spite of their best preventative efforts.

To counter the various threats to personal security, individuals may resort to carrying personal protection devices. Such devices may be stowed in pockets, purses, glove compartments, or other locations that may prove difficult to quickly access in an emergency, or relatively cumbersome to carry, weather-dependent, and/or training intensive. Firearms, for instance, come with a high requisite level of training as well as strict limitations on where and how the firearms can be legally carried. Electric taser devices or stun guns can temporarily disable an assailant, but may pose a shock risk to the user in rainy or wet conditions. Pepper spray canisters are able to temporarily blind an assailant and thereby provide a brief window for escape, but as the spray pattern tends to disperse in windy conditions, the effectiveness of such devices may vary. Hence, there is a need for an improved personal security device that is easily accessible, compact, and performs multiple different security functions in all weather conditions.

### SUMMARY

A wearable, multi-functional personal security device is disclosed herein. The personal security device includes, in an example embodiment, a housing that is configured to be worn by a user, e.g., as a wristwatch, pendant, or clip-on accessory. The housing contains multiple security modules, with each security module configured to separately or cooperatively perform a designated security function. As used herein, the term “security module” refers to one or more specially-programmed processors and associated hardware devices protected by and contained within the housing. The various security modules wirelessly interface with an external cellular device, e.g., a smart phone or cellular-enabled tablet. In terms of functionality, the security modules may perform only those security functions specifically described herein, or the security modules may be integrated into an existing “smart watch”. In either configuration, the security modules are selectively controlled in conjunction with an application (“app”) according to the disclosed method in order to perform the disclosed security functions.

The personal security device includes a position module configured to determine a geo-position of the housing, e.g., as a set of global positioning satellite (GPS)-based coordinates, a communications module that detects proximity of the cellular device with respect to the housing, a programmable “smart” switch, and an alert button connected to or in communication with the smart switch that is moveable with respect to the housing.

Regarding the multiple security modules, each is responsive to a predetermined activation sequence of the smart switch to provide a corresponding security function, with “sequence” possibly including a series of on/off button-pushing pulses or a sustained pulse. A first input signal may activate the smart switch to command a first security function when the communications module detects the cellular device. That is, the first input signal may be effective only when the cellular device is detected in a predetermined range or proximity of the housing, e.g., within 5-30 meters (m) of the using 2.4 GHz BLUETOOTH or WI-FI communications protocols. Second and third input signals, which may be the same or different, may activate or command respective second and third security functions that are different from the first security function. The second and third security functions possibly provide an escalated response in situations in which the first security function alone is inadequate.

The second and third security functions may include the emission of high-intensity light, whether as a constant light beam(s) or a strobe light, and high-intensity/piercing sound, respectively, in which case the second and third security modules respectively include a light-emitting diode (LED) or other suitable light source and audio speakers and/or a siren. The first security function may include transmission a geo-position of the housing to a predetermined set of the user's contacts via communication of the communications module with the cellular device.

The personal security device may optionally include wrist straps connected to the housing and configured to secure the housing to a wrist of the user such that the personal security device has the appearance of a wristwatch. Such a configuration may reduce the probability that an assailant will recognize the personal security device as anything other than a wristwatch, which in turn may increase the chances of a successful alert response.

The communications module may include a GPS receiver in some embodiments. The GPS receiver may be a dedicated antenna used solely for the first security function or a shared antenna performing other locational services, e.g., as part of an optional smart watch embodiment. In this case, the geo-position of the housing includes GPS coordinates corresponding to the position of the housing.

Additionally, in some optional embodiments the personal security device may include a proximity sensor configured to detect proximity of a transmitter device with respect to the housing. A processor may be programmed to activate the second and/or third security modules at a predetermined intensity level in response to the transmitter moving out of a predetermined range of the housing. By way of an illustrative example, such an embodiment may allow a user of the security device to closely monitor a child or other adult in a crowded environment, with the second and/or third security functions alerting the user to the fact that the monitored person has moved outside of the predetermined range. This in turn allows the user to locate the monitored child or adult before the person becomes lost.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and representative modes for carrying out the present disclosure when taken in connection with the accompanying drawings and the appended claims. Moreover, this disclosure expressly includes any and all combinations and sub-combinations of the elements and features presented above and below.

### BRIEF DESCRIPTION OF THE DRAWINGS

FIG. 1 is a schematic illustration of a multi-functional personal security device according to an example embodiment of the present disclosure.

FIGS. 2A and 2B are schematic perspective view illustrations of an example embodiment wristwatch embodiment of the multi-functional personal security device whose operation is schematically depicted in FIG. 1.

FIGS. 3A, 3B, and 3C are schematic plan view illustrations of possible cell phone applications usable within the framework of the multi-functional personal security device of FIGS. 1, 2A, and 2B.

FIG. 4 is flow chart describing example functionality of the multi-functional personal security device of FIGS. 1, 2A, and 2B.

The present disclosure is susceptible to various modifications and alternative forms, and some representative embodiments have been shown by way of example in the drawings and will be described in detail herein. It should be understood, however, that the novel aspects of this disclosure are not limited to the particular forms illustrated in the appended drawings. Rather, the disclosure is to cover all modifications, equivalents, combinations, sub-combinations, permutations, groupings, and alternatives falling within the scope and spirit of the disclosure as defined by the appended claims.

### DETAILED DESCRIPTION

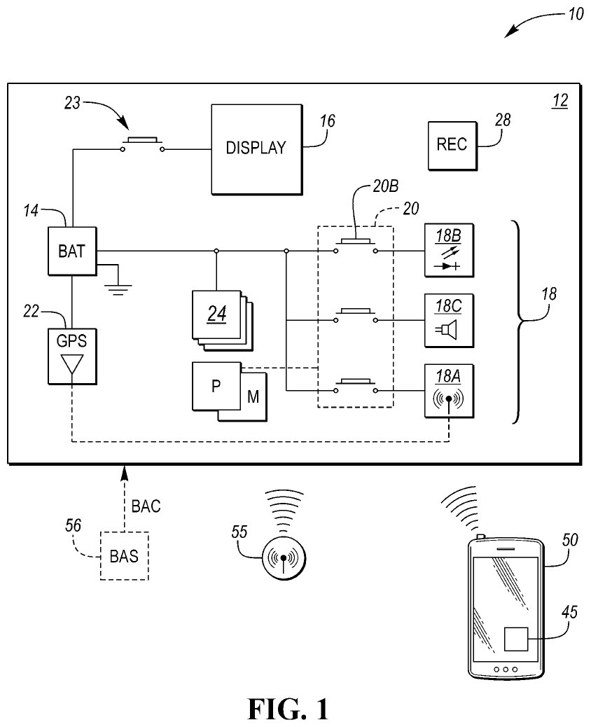

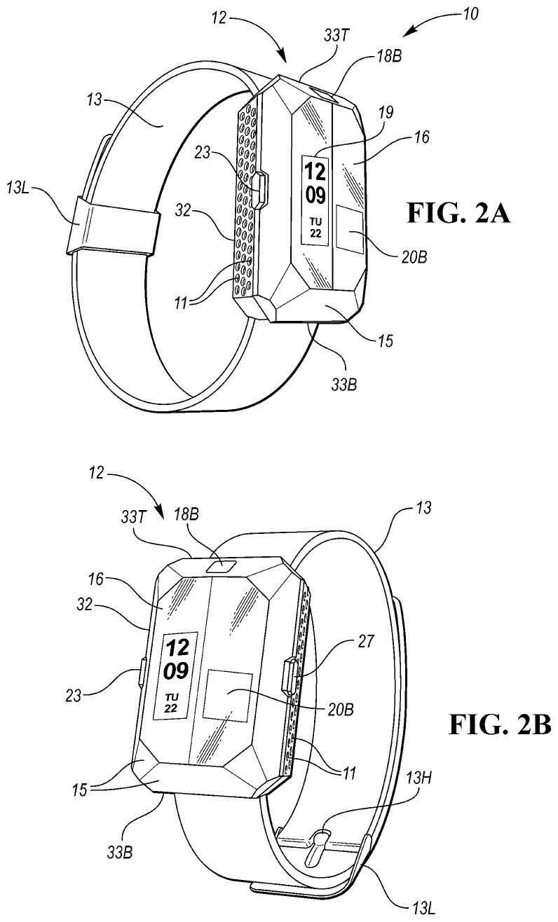

Referring to the drawings, wherein like reference numerals are used to identify like or identical components in the various views, FIG. 1 schematically illustrates a wearable multi-functional personal security device 10. The personal security device 10 may be worn by an individual user to provide, to a casual observer, the appearance of a conventional wristwatch or bracelet, as shown for instance in the example embodiment of FIGS. 2A-C, while remaining easily accessible, stylish, and compact. While a wristwatch embodiment is described hereinafter for illustrative consistency, other embodiments may be readily envisioned, such as but not limited to pendants, badges, clip-on accessories, etc. Likewise, while the personal security device 10 may be a dedicated security device in some embodiments, in other embodiments the personal security device 10 may have the structure and function of a conventional smart watch, such that the various hardware devices of the smart watch are situationally controlled in the manner set forth herein to provide security functions not found in conventional smart watches.

The personal security device 10 of FIG. 1 includes a protective outer housing 12 that contains or supports a number of internal components. In the embodiment of FIG. 1, the personal security device 10 includes a battery (BAT) 14, a display screen (DISPLAY) 16, and a plurality of security modules 18, including at least first, second, and third security modules 18A-C. A “smart” switch 20, i.e., a programmable switching device whose switching response or on/off state varies depending on the particular input to the smart switch 20, such as from one or more processors (P) as explained below, may be used to individually connect the various security modules 18A-C to the battery 14 or otherwise activate the security modules 18A-C.

Additionally, the processor(s) (P) may be remotely or directly programmable by a user of the personal security device 10 so as to provide a customizable set of user-selectable security options, e.g., via an application (“app”) 45 that is accessible via a cell phone or other cellular device 50 as set forth below. The app 45 may be synchronized (“synched”) with the personal security device 10 using BLUETOOTH, WI-FI, or any other suitable short-range wireless protocol, with “short-range” herein referring generally to 30 meters (m) or less.

Also as shown in FIG. 1, the smart switch 20, when commanded closed, may complete an internal electrical circuit or otherwise supply a calibrated voltage and current from the battery 14 to each of the security modules 18A-C at a level sufficient for powering the individual security modules 18A-C. Typically, the battery 14 may be a 5-volt direct current (5 VDC) lithium ion or alkaline battery, or another suitable chargeable or replaceable low-voltage energy storage device.

The first security module 18A is configured to provide the first security function, and may be embodied as a radio frequency (RF) communication module that, when activated via a predetermined action sequence of the smart switch 20, causes the present geo-position of the personal security device 10 to be transmitted to the user's preferred list of contacts, e.g., via BLUETOOTH or WI-FI communication with and relay of information using the cellular device 50. Recipients and/or 911 “SOS” emergency contacts may also receive a pre-recorded alert message from the user, to which is appended the present geo-coordinates of the personal security device 10, with such recipients typically including parents, close family members, or friends, the police, or other authorities, e.g., as selected by the user beforehand from a contact priority list.

To enable such location services, the personal security device 10 may be equipped with a position module 22, e.g., a global positioning system (GPS) receiver or antenna as noted above that is in radio communication with orbiting GPS satellites (not shown), as is well known in the art. When the first security module 18A is activated and detects the cellular device 50, the processor(s) (P) may automatically request transmission of the present GPS coordinates via the cellular device 50 and the app 45 in response to a predetermined activation sequence of the smart switch 20, either in conjunction with or independently of any activation of the respective second and/or third security modules 18B and 18C.

In some embodiments, as soon as the smart switch 20 is activated the first security module 18A (i.e., the communications module) will communicate with the cellular device 50 and thereby command the cellular device 50 to transmit the present GPS coordinates of the personal security device 10 from the position module to the user's pre-selected list of contacts.

The second security module 18B is configured to provide the second security function, and may be embodied a light source, such as a high-intensity/high-lumen light or strobe light. Light emitted by the second security module 18B is at an intensity level sufficient for temporarily blinding or impairing the vision of an assailant, which in turn may help provide a window of time in which the user can attempt to escape to safety. For instance, the second security module 18B may include a set of light-emitting diodes (LEDs) or other lighting sources outputting at least 80 lumens in some embodiments, or over 100 lumens in other embodiments. The strobe light embodiment can also be used to quickly attract attention to the user when the user is alone in the dark or in an otherwise dangerous situation in which such lighting may be of use in aiding detection by a potential rescuer.

The third security module 18C is configured to provide the third security function disclosed herein, and may be embodied as a high-intensity, high-frequency audible alarm such as a piercing tone or a siren. Volume of the third security module 18C may be aided by use of audio speakers, the openings 11 of which are shown in FIGS. 2A-C, e.g., as circular vents. Volume levels should be sufficient for startling or causing ocular discomfort in an assailant, for instance 80-100 dB or more, and for quickly drawing attention to the user.

The display module 16 of FIG. 1 may display such information as a digital clock readout and remaining battery life, for instance as an organic LED (OLED) readout, and thus the personal security device 10 may function as an ordinary watch when the various security functions disclosed herein are not required. The personal security device 10 may also include a display switch 23 configured to turn the display screen 16 on and off as needed. Furthermore, the personal security device 10 of FIG. 1 may optionally include one or more additional monitoring devices 24. By way of example, the monitoring devices 24 may include devices such as but not limited to a pedometer, a tactile device configured, e.g., to vibrate, and thus indicate successful communication with the cellular device 50, and/or a proximity sensor as described below.

In a possible embodiment, the monitoring devices 24 may include an alcohol alert module that is programmed to receive a blood alcohol content reading signal (arrow BAC) from an external blood alcohol sensor (BAS) 56, and automatically alert some or all of the user contacts with the user's geo-location when the user's blood alcohol level exceeds the threshold. For instance, the blood alcohol sensor (BAS) 56 may be configured to measure a user's blood alcohol content using conventional breath, blood, and/or skin contact-based measurement techniques. A monitoring device 24 configured in this manner may receive the blood alcohol content reading signal (arrow BAC), compare the blood alcohol levels reported in the received blood alcohol content reading (arrow BAC) to a threshold, e.g., 0.08% or 0.1%, and automatically alert the user's preferred/preselected contacts that the user may be impaired, along with the user's location as determined using the position module 22 of FIG. 1. Configuring one of the monitoring devices 24 in this manner may prompt one of the contacts to call or text the user and inquire into the user's condition. In this manner, the user may be able to avoid situations in which the user's judgment and/or driving ability is impaired.

The personal security device 10 may also optionally include a recording module (REC) 28, e.g., a microphone and/or a still or video camera, operable for recording video and audio information. Such recorded information may be stored in memory of the personal security device 10, in memory of the cellular device 50, and/or remotely/in the cloud to be transmitted to the user's selected emergency contacts when the smart switch 20 is activated using a predetermined sequence, i.e., an easily-remembered, user-selected sequence of activation triggering activation of the disclosed security features. Such a recording module 28 may also be used to facilitate hands-free activation/deactivation of the various features of the personal security device 10, e.g., using voice-recognition software.

Activation of the smart switch 20 according to a corresponding, predetermined activation sequence, and possibly using a predetermined voice command in some embodiments, may connect the second and third security modules 18B and 18C to the battery 14 to directly energize the security modules 18B and 18C, and provide standby power to the first security module 18A. The smart switch 20 may be programmed with predetermined logic states in which a predetermined sequence of depressions or pulses of a button 20B (see FIGS. 2A-C) mounted to the smart switch 20 and moveable with respect to the housing 12, such as in the position depicted in FIGS. 2A and 2B, may instruct the processor(s) (P) to execute a particular control action. For instance, in a non-limiting embodiment, a sustained pulse or multiple quick depressions or pulses of the button 20B may request transmission of the present GPS location of the personal security device 10 to the cellular device 50, while additional pulses of the button 20B may be used to request activation of the second and third security modules 18B and 18C to provide strobe and audible alarm warnings, respectively.

Optionally, transmission of the GPS location may be concurrent with transmission of an SMS text message or voice message identifying whether the second and third security modules 18B or 18C are also activated, thereby communicating a relative alarm level to the list of contacts. That is, a user may activate the first security function to let the user's preferred contacts know that the user is in a particular location, which may or may not signify an emergency situation. The user may simply be lost or stranded. Or, the user may be in a threatening situation or an active crime target, in which case the user may activate the second and third security modules 18B and 18C, and in which case knowledge of the escalated alert level may be beneficial to the contacts. Likewise, the particular contacts may differ based on the level of the alert in some embodiments, e.g., with the police alerted only when the second and third security modules 18B and 18C are activated.

As noted above, the monitoring devices 24 may include an optional proximity sensor. In such an embodiment, an external user may wear or carry a transmitter device 55, e.g., a BLUETOOTH transmitter, an RF transmitter, or other local positioning system that broadcasts its relative location to the personal security device 10. The user of the personal security device 10, via the application (“app”) 45, may program a calibrated range into memory (M). When the user of the transmitter device 55 moves outside of the predetermined range or proximity, this detected action may trigger activation of a particular responses, e.g., activation of a strobe via the security module 18A and/or a predetermined audio alarm message (“child out of range”, a repeating chirp, or other suitable alarm at a level that is audible to the user of the personal security device 10). Such an embodiment may quickly alert a parent or guardian wearing the personal security device 10 that a child or other monitored person has wandered outside of the calibrated range, which may be useful in crowded environments where becoming lost or abducted may be more likely to occur.

As shown in the example embodiment of FIGS. 2A-C, the housing 12 of the personal security device 10 may be embodied as a weatherproof enclosure, such as an impact-resistant molded plastic clamshell, box, or other suitable shell enclosing the various components shown in FIG. 1. The housing 12 may have a multi-faceted surface as shown, i.e., multiple chamfered or other angled surfaces 15 slope toward a display face 19 of the display module 16 shown in FIG. 1. The housing 12 may be rectangular as shown, or may define other geometric shapes in different embodiments.

Adjustable straps 13 with holes 13H and a latch 13L may be connected to the housing 12 to enable the personal security device 10 to be worn as a watch on a wrist of a user. In this manner, the personal security device 10 may be used during all times of day and under all weather conditions in the manner of a conventional watch, with the specialized security features securely hidden within the housing 12 and not otherwise detectable by an assailant or even a casual observer. Similarly, the personal security device 10 may be comfortably used by outdoor enthusiasts such as mountain bikers, skiers, runners, hikers, etc., in the manner of a typical watch, with the hidden security features of the personal security device 10 readily available should the user happen to become lost or get separated from their group.

In the particular wristwatch embodiment depicted in FIGS. 2A-C, the display face 19 is an LCD screen, e.g., an OLED display with a black gloss finish arranged in a column on one side of the display face 19 as shown, with such an OLED display being operable for displaying information as the day, month, and year, as well as other digital readouts such as distance or number of steps traveled when the personal security device 10 includes the optional pedometer noted above.

A distinct advantage of the personal security device 10 is its compact design and inconspicuous appearance. Thus, the ability to blend in as a conventional low-profile wristwatch may desirable, and may in emergency circumstances preserve the element of surprise, due to the likelihood that an assailant would not recognize the personal security device 10 as anything other than an ordinary wristwatch. To this end, the button 20B triggering overall security operation of the smart switch 20 of FIG. 1 may be configured to blend, as seamlessly as possible, into the display face 19. For example, the button 20B may be constructed as part of the display face 19, e.g., gloss black or black mirror finish material, with a surface 20BS flush with the rest of the display face 19. The button 20B therefore has the appearance of being a continuous section of the display face 19. In a possible embodiment, the button 20B may be arranged in the bottom right corner of the display face 19 opposite the OLED display, such that a user can quickly locate the button 20B by pressing the unlit area of the display screen 19 opposite the OLED display.

The second security module 18B may be arranged alongside or adjacent to the display face 19. For example, with the housing 12 having top, bottom, and side surfaces 33T, 33B, and 32, respectively, as viewed by the user, the second security module 18B may be arranged proximate the top surface 33T as shown, with “top” referring to the normal viewing perspective of the display face 19 by a user wearing the device 10. Other configurations are possible, such as an embodiment in which LEDs surround a perimeter of the display face 19 or are mounted to other locations not depicted in FIGS. 2A and 2B.

Also shown in FIGS. 2A-C are the speaker openings 11 noted above, which pass through the material of the housing 12 to the security module 18C contained therein. The speaker openings 11 may be arranged on some or all lateral surfaces 32 of the housing 12 to uniformly direct sound from an audible alarm emitted by the security module 18C. Also positioned on one of the lateral surfaces 32 is the display switch 23 enabling on/off functionality of the display face 19, with the display switch 23 possibly enabling manual input for changing the date/time settings or other typical watch display functions as is known in the art. In some embodiment, turning on the display face 19 may connect the display module 16 of FIG. 1 to the battery 14 without connecting the battery 14 to the security modules 18A-C, thus enabling operation and use of the personal security device 10 as an ordinary watch or fitness device in a Fitness Mode when its various security options are not required.

Also shown in FIGS. 2B and 2C is a power/data port 27, for instance a micro-USB port. The power/data port 27 provides a connection point to the cellular device 50 of FIG. 1 and/or to a wall outlet or battery charger (not shown) for charging of the battery 14 and/or programming of the processor(s) (P), e.g., upgrading of software and/or firmware. Programming may also be achieved via the app 45 using the cellular device 50 or a website linked to such an app 45. The housing 12 may include hinges from which the housing 12 may be easily detached from the straps 13 and worn, e.g., in a pocket or inside a shirt with the assistance of an optional clip 37.

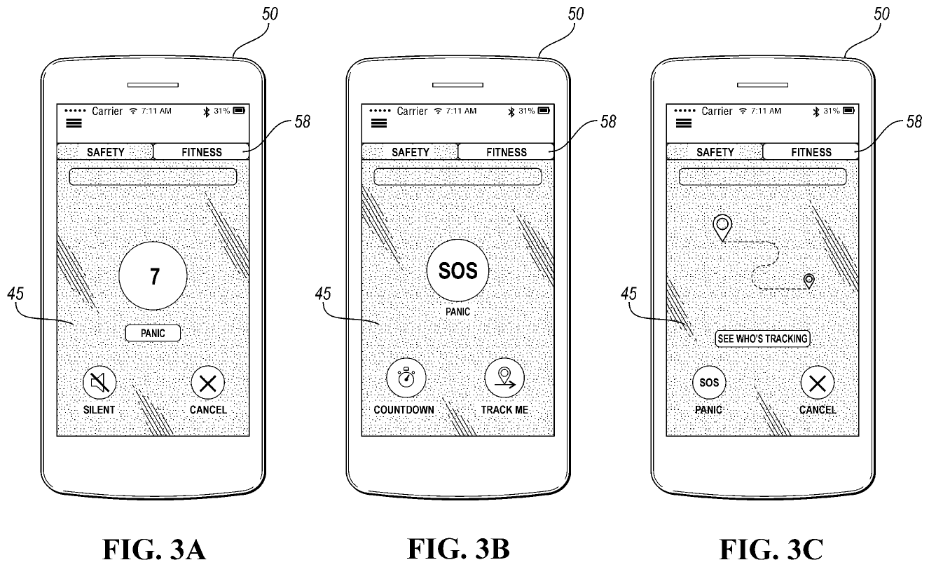

Referring briefly to FIGS. 3A-C, the above-noted cellular device 50 shown schematically in FIG. 1 may be a cellular phone providing an intuitive interface. In an example usage scenario, a user may download the app 45 of FIG. 1 to the cellular device 50, synchronize the app 45 with the cellular device 50, and then strap the personal security device 10 to a wrist (in the wristwatch embodiment of FIGS. 2A and 2B) or to other part of the user's body in other embodiments. Alerts may be sent, in the various manners set forth above, by pressing the button 20B.

Different operating modes of the personal security device 10 may be used in different threat situations. In an embodiment, operating modes may include a “Panic Mode”, “Silent Panic Mode”, “Countdown Mode”, and “Tracking Mode”. The Panic Mode and Silent Panic Mode are operated through the app 45 and the cellular device 50, while the Countdown Mode and Tracking Mode operated through the app 45. A possible appearance of the displayed information in the Silent Panic Mode is shown in FIG. 3A, with Panic Mode (SOS) shown in FIG. 3B and the Tracking Mode depicted in FIG. 3C.

In Panic Mode, a possible scenario includes a user in imminent danger and requiring immediate assistance. For instance, the user may be in the process of being robbed or assaulted, or may believe that such actions are imminent. The user may respond by quickly pressing the button 20B of FIGS. 1-2B in a predetermined succession, e.g., three times. Depending on the programmed response chosen ahead of time by the user, some or all of the security modules 18A-C may be activated in response to such a sequence. For instance, an SMS text message or messages with the user's location may be transmitted to the user's pre-selected contacts, a mobile 911 call may be initiated through rapid SOS (FIG. 3B), and the screen of the user's cellular device 50 and the display screen 19 of the personal security device 10 may display a corresponding notification, e.g., “ALARM ACTIVATED!”, to alert the user that the security features have successfully activated.

In Silent Panic Mode, a possible scenario includes the user hiding from a possible attacker while in imminent danger. A home invasion may be in process with the user present and undetected, or the user may have been kidnapped, is being followed, or otherwise does not wish to draw the attacker's attention. The user may press and hold the button 20B for a pre-selected duration, e.g., 3 or more seconds, to silently active the security functions noted above. The SMS text messages may be transmitted with location details, as such actions can take place discreetly without alerting the attacker. A corresponding message may be discreetly displayed on the screen of the cellular device 50 and the personal security device 10, e.g., “SILENT ALARM ACTIVATED!”.

In some embodiments, if a silent alert is not cancelled after a preset duration, e.g., 1 minute, the personal security device 10 may default to Panic Mode. In an embodiment, the Panic and Silent Panic Modes activated via the personal security device 10 may only be cancelled via the app 45. In a serious emergency, there might be a scenario in which an assailant attempts to cancel the alert. In such cases, the mode may be cancelled only by the user accessing the app 45, such as by entering a multi-digit password. Such a password may be the same password used to unlock the cellular device 50, or some other easily-recalled sequence, so as to aid recall of the password under duress. In the case of accidental activation of the Panic or Silent Panic modes, the app 45 may be configured to allow a fixed window of time, e.g., 10 seconds, for the user to cancel the alert. During this window, tactile feedback such as vibration of the cellular device 50 may be used to alert the user to the impending onset of the selected mode.

The Countdown Mode provides the user with an option for proactively setting an alert in anticipation of potential danger. The user can select a countdown duration until the user expects to arrive in a safe location. If the countdown duration expires or elapses, this automatically results in execution of one of the above-described Panic or Silent Panic operating modes. Scenarios for the Countdown Mode may include the user riding alone in a taxi with a driver behaving in a manner that causes the user to become apprehensive, or when walking or traveling alone in an unfamiliar location. The user may select the Countdown Mode from the cellular device 50, such as shown in FIG. 3B, as in the expected scenario danger is not imminent and thus the user has the luxury of proactively accessing the cellular device 50. The Countdown Mode may display a digital readout of the remaining time via the external device, coupled with audible feedback toward the end of the countdown duration, such that the user is afforded ample time to cancel the alert.

Tracking Mode, with a corresponding graphical depiction shown in FIG. 3C, may be useful in situations in which the user prefers to be cautious by informing predetermined contacts of the user's whereabouts. As with the Countdown Mode, the user can select the Tracking Mode from the cellular device 50 as shown in FIG. 3C. When initiated, tracking of the user's location commences, with periodic updates of the user's location sent to the user's pre-selected contacts. The contacts will be able to see the path of movement 55 of the user until the end of the Tracking Mode. A notification may be displayed on the display screen 19 of the device 10 indicating that the Tracking Mode is active.

In FIGS. 3A-C, the top of the screen includes tabs 58 that a user may touch to select between Safety and Fitness Mode options of the personal security device 10. Fitness Mode options may include a pedometer or fitness tracker recording the user's daily step count, calories, and distance traveled, with history tracking and comparative statistics. Data corresponding to associated Fitness Mode functions may be displayed on the cellular device 50 as well as the personal security device 10, with the user being able to customize the fitness and security settings to their preference.

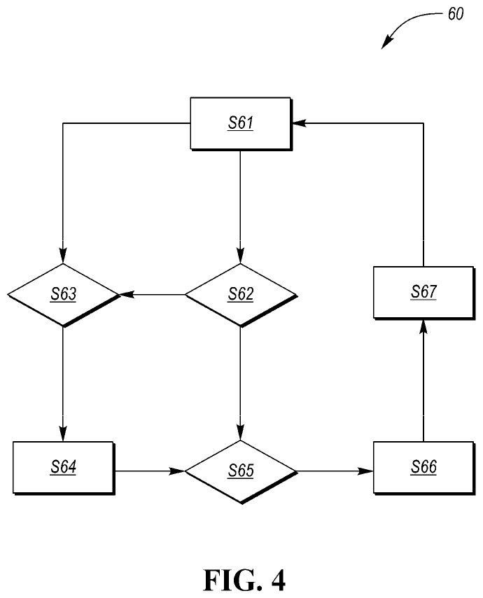

Referring to FIG. 4, an example method 60 for using the personal security device 10 may be programmed into memory (M) and/or used in conjunction with the app 45 to provide the described functionality. An embodiment of such a method 60 commences with step S61 wherein a user of the personal security device 10 presses or otherwise activates the smart switch 20 in response to a perceived threat or emergency situation. While manual activation of the smart switch 20 via sequential pressing of the button 20B is envisioned in some embodiments, other embodiments may use simple pre-programmed voice commands to the same ends, e.g., by speaking aloud a key phrase such as “help!” a certain number of times. The method 60 proceeds to step S62 when the state of the smart switch 20 is received and thus known by the processor(s) (P).

At step S62, the processor(s) P determine whether the state requested at step S61 corresponds to a sequence of activations or depressions of the button 20B indicative of a first level of response (R1). For instance, the first level of response (R1), i.e., a first security response, may be requested when a predetermined number of depressions of the button 20B are detected in a short interval, e.g., three or more depressions within 1-2 seconds of each other, or a particular spoken word or phrase is detected as a first input signal. The method proceeds to step S65 if such an action sequence is detected. Otherwise, the method 60 proceeds to step S63.

Step S63 includes determining if the requested state at step S60 corresponds to a predetermined sequence of activations or depressions of button 20B indicative of a second level of response (R2), e.g., three depressions of the button 20B or another particular spoken word or phrase. If so, the method 60 proceeds to step S64, otherwise the method 60 returns to step S61.

At step S64, the processor (P) activates the security module 18B-C, e.g., automatically energizes the security modules 18B-C, such as by closing a circuit with the battery 14. The method 60 then proceeds to step S65.

At step S65, the method 60 includes detecting whether the cellular device 50 is within proximity of the personal security device 10. As part of step S65, the security module 18A (the communications module) may communicate with the linked portable device 50 via BLUETOOTH, Wi-Fi, or other wireless communications standard or protocol. The method 60 thereafter proceeds to step S66.

Step S66 entails establishing a communications link with the cellular device 50 and extracting, from memory (M) or from the cloud, a predetermined list of emergency contacts for receipt of the GPS position information. The method 60 then proceeds to step S67.

Step S67 includes reading the present GPS coordinates of the personal security device 10 from the position module 22 of FIG. 1 and transmitting the present GPS coordinates to the contacts from the predetermined list of step S66. Step S67 may entail activating the security device 18A and controlling the security module 18A via the processor(s) (P), e.g., as a transceiver or transponder, such that the present GPS coordinates are broadcast via cell phone or text message to the user's predetermined contacts. The method 60 thereafter proceeds to step S61.

In all embodiments described above, in case of accidentally activating an alert, the app 45 may be configured to allow the user to cancel the alert. During this time, the cellular device 50 may be vibrating continuously and displaying a suitable notification, e.g., “caution mode active/tap to cancel.” The alert may be cancelled at any time during this duration by pressing the cancel icon on the cellular device 50, e.g., using a multi-digit passcode known only to the user. This feature may help prevent an assailant from canceling the alert.

By using the personal security device 10 described above, a user may enjoy the advantage of the precious additional seconds that the element of tactical surprise may afford. Such seconds may be the difference between the user safely escaping a dangerous situation and the same user becoming a crime victim. While most users will hopefully never require access to the various security features of the personal security device 10, the user may enjoy peace of mind knowing that such features remain available as an escalating response to a perceived threat under all weather conditions. When security features are not required, additional useful features such as time and fitness tracking, proximity monitoring of children, elderly, or special needs persons, and other helpful features remain available.

While the best modes for carrying out the disclosure have been described in detail, those familiar with the art to which this disclosure relates will recognize various alternative designs and embodiments for practicing the disclosure within the scope of the appended claims. It is intended that all matter contained in the above description or shown in the accompanying drawings shall be interpreted as illustrative only and not as limiting.

What is claimed is:

1. A wearable multi-functional personal security device comprising:
a housing configured to be worn by a user of the personal security device;
a position module contained within the housing and configured to determine a geo-position of the housing;
a communications module contained within the housing, and configured to detect a cellular device within a predetermined proximity of the housing;
a programmable smart switch contained within the housing; and
first, second, and third security modules contained within the housing and providing respective first, second, and third security functions in response to predetermined corresponding first, second, and third activation sequences of the smart switch, with the first security module activated in response to the first activation sequence only when the communications module detects the cellular device;
wherein the first security function includes a transmission of the geo-position of the housing to a predetermined set of user contacts via the cellular device, and wherein the second and third security functions include an emission of high-intensity light and an emission of high-intensity sound, respectively.

2. The personal security device of claim 1, wherein the second and third security modules include a light-emitting diode strobe light and an audio speaker, respectively.

3. The personal security device of claim 1, further comprising: wrist straps connected to the housing and configured to secure the housing to a wrist of the user.

4. The personal security device of claim 1, wherein the communications module includes a global positioning system (GPS) receiver and the geo-position of the housing includes GPS coordinates of the housing, as determined by GPS receiver.

5. The personal security device of claim 1, further comprising: a proximity sensor configured to detect proximity of a transmitter device to the housing, wherein at least one of the second and third security modules is activated in response to the transmitter moving out of a predetermined range of the housing.

6. The personal security device of claim 1, further comprising: a display screen and a button operatively connected to the smart switch that is moveable with respect to the housing in response to a force from the user, wherein a surface of the button is flush with, and constructed of the same material as, the display screen.

7. The personal security device of claim 1, wherein the first, second, and third security functions are configured to activate in response to a corresponding predetermined voice command.

8. The personal security device of claim 1, further comprising: a recording module configured to record a predetermined audio message of the user, wherein the first security function includes a transmission of the geo-position and the predetermined audio message.

9. The personal security device of claim 1, wherein the personal security device is configured to provide a plurality of operating modes, including at least a Panic Mode in which the first, second, and third security functions are enabled and a Silent Panic Mode in which only the first security function is enabled.

10. The personal security device of claim 9, wherein the plurality of operating modes further includes a Countdown Mode in which a user sets a countdown duration, with the personal security device automatically executing the Panic Mode or the Silent Panic Mode if the Countdown Mode is not cancelled before the countdown duration elapses.

11. The personal security device of claim 10, wherein the plurality of operating modes further includes a Countdown Mode in which a user sets a countdown duration, with the personal security device automatically executing the Panic Mode or the Silent Panic Mode if the Countdown Mode is not cancelled before the countdown duration elapses.

12. The personal security device of claim 10, wherein the plurality of operating modes further includes a Tracking Mode in which the position module periodically transmits the geo-position to the user contacts.

13. The personal security device of claim 1, wherein the first, second, and third activation sequences are programmable via an application (“app”) of the cellular device.

14. The personal security device of claim 1, wherein the personal security device is configured to selectively operate in a Fitness Mode in which a step count or a distance travelled by the user is tracked by the personal security device.

15. The personal security device of claim 1, further comprising: an alcohol alert module programmed to receive a blood alcohol content reading signal from an external blood alcohol sensor, compare a blood alcohol level from the received blood alcohol content reading to a threshold, and automatically alert the predetermined set of user contacts with the user's location when the blood alcohol level exceeds the threshold.

16. A wearable multi-functional personal security device comprising:
a housing connected to wrist straps, and configured to be worn on a wrist of a user of the personal security device, the housing including a display screen;
a position module contained within and configured to determine a geo-position of the housing as a set of GPS coordinates;
a communications module contained within the housing, and configured to detect a cellular device within a predetermined proximity of the housing, wherein the communications module includes a GPS receiver;
a programmable smart switch contained within the housing;
a button operatively connected to the smart switch and mounted flush with the display screen; and
first, second, and third security modules contained within the housing and providing respective first, second, and third security functions in response to predetermined corresponding first, second, and third activation sequences of the smart switch, with the first security module activated in response to the first activation sequence only when the communications module detects the cellular device;
wherein the first security function includes a transmission of the geo-position of the housing to a predetermined set of user contacts via the cellular device, and wherein the second and third security functions include an emission of high-intensity light and an emission of high-intensity sound, respectively; and
wherein the personal security device is configured to provide a plurality of selectable operating modes, including at least a Panic Mode in which the first, second, and third security functions are enabled and a Silent Panic Mode in which only the first security function is enabled.

17. The personal security device of claim 16, further comprising: a proximity sensor configured to detect proximity of a transmitter device to the housing, wherein at least one of the second and third security devices is activated in response to the transmitter moving out of a predetermined proximity of the housing.

18. The personal security device of claim 17, wherein the plurality of operating modes further includes a Tracking Mode in which the position module periodically transmits the geo-position to the user contacts.

19. The personal security device of claim 16, further comprising: a recording module operable for recording video and/or audio information, wherein the recorded video and/or audio information is transmitted to the predetermined set of user contacts when the smart switch is activated using a predetermined sequence.

20. The personal security device of claim 16, further comprising: an alcohol alert module programmed to receive a blood alcohol content reading signal from an external blood alcohol sensor, compare a blood alcohol level from the received blood alcohol content reading to a threshold, and automatically alert the predetermined set of user contacts with the user's location when the blood alcohol level exceeds the threshold.
